(19) United States
(12) Patent Application Publication
(10) Pub. No.: US 2016/0286418 A1
(43) Pub. Date: Sep. 29, 2016

(54) FADING SIMULATOR AND MOBILE TERMINAL TESTING SYSTEM

(71) Applicant: ANRITSU CORPORATION, Kanagawa (JP)

(72) Inventor: Akihiko Suenaga, Kanagawa (JP)

(21) Appl. No.: 14/983,710

(22) Filed: Dec. 30, 2015

(30) Foreign Application Priority Data
Mar. 24, 2015 (JP) 2015-061611

(51) Int. Cl. H04W 24/06

(52) U.S. Cl. CPC H04W 24/06

(57) ABSTRACT

An object of the present invention is to provide a fading simulator that is capable of performing designated fading processing without depending on a method of an operator's input connection. The fading simulator 20 includes an arithmetic operation unit 22 that performs fading processing on m baseband signals that are received in m first input terminals to which identifiers are attached respectively, and thus outputs the fading-processed n baseband signals, and an input control unit 21 that receives a transmission signal which includes a pair of the identifier and the baseband signal, in m second input terminals, detects the identifier which is included in the transmission signal, and thus inputs the baseband signal that is paired with the identifier, into the first input terminal to which the same identifier as the identifier that is included in the transmission signal is attached.

### TECHNICAL FIELD

The present invention relates to a technology of fading processing that simulates fading which occurs due to spatial propagation between a mobile communication terminal and a base station, and particularly to a technology for automatically recognizing a connection between a base station simulation device and a fading simulator.

### BACKGROUND ART

In recent years, mobile communication terminals have rapidly been developed such as a portable telephone and a mobile terminal. A radio wave from a base station reaches the mobile communication terminal, in a state of being a multi-path wave due to reflection, dispersion, diffraction, or the like that results from geographical features of a propagation path for the radio wave or a building structure on the propagation path. Amplitude and phase of the radio wave change depending on place. In a case where the mobile communication terminal receives the radio wave from the base station while on the move on the propagation path, fading occurs due to the multi-path radio wave. As a result, the fading exerts great influence on communication. For this reason, when valuing communication performance of the mobile communication terminal, a device is used that is called a fading simulator which simulates a radio propagation environment, along with a pseudo-base station device that simulates a base station (for example, refer to Patent Document 1).

On the other hand, in the mobile communication terminal of which typical examples are a portable telephone and the like, information is frequently downloaded over the Internet, and a larger amount of downlink information transmission is required. However, an increase in a frequency band for increasing an amount of information brings about a decrease in the number of terminals that are available for communication, but not an increase in an amount of information transmission over an entire system. As one scheme to solve this problem, there has been proposed a multiple input multiple output (MIMO) scheme.

This MIMO scheme is based on the principle that, in actual mobile communication, propagation channels between M antennas at the base station side and N antennas at the terminal side become multi-path propagation channels, and that, if each of the multi-path propagation channels is regarded as an independent channel and characteristics of each channel is known, it is possible to separate a signal that is output from each antenna at the transmission side, from a signal resulting from multiplexing, which is received in each antenna at the reception side.

The number of multi-path propagation channels that constitute the MIMO is equivalent to the number of combinations of the number M of antennas at the base station side and the number N of antennas at the mobile communication terminal side. On the assumption that the MIMO scheme is employed in a mobile communication system, in the fading simulator, fading processing in accordance with a propagation channel is performed on each of the generated multiple baseband signals, and thus a fading signal is generated.

### RELATED DOCUMENT

### Patent Document

[Patent Document 1] JP-A-2012-195895

### DISCLOSURE OF THE INVENTION

### Problem that the Invention is to Solve

Here, a technology in the related art is described in detail. For testing of reception performance of a testing-target mobile communication terminal, m baseband signals BX1 to BXm are generated by a baseband signal generation unit 110, based on a predetermined communication scheme, using a base station simulation device 100 as shown with a dotted line in FIG. 4, the baseband signals BX1 to BXm are transmitted by a transmission unit 121 within a transmission and reception unit 120 from output terminals X1 to Xm to a mobile communication terminal 300, a response from the mobile communication terminal 300 is received in a reception unit 122, and the received response is interpreted and thus tested in an interpretation unit 130. In a case where fading testing is performed (which, in some cases, is referred to as a fading simulation mode), a fading simulator is configured to receive the digital baseband signals BX1 to BXm from the baseband signal generation unit 110 of the base station simulation device 100, to cause an arithmetic operation unit 210 to generate desired fading, and to send the generated fading to a transmission unit 121. Moreover, the fading simulator may be configured to receive the baseband signals BX1 to BXm from the outside, instead of from the baseband signal generation unit 110.

In the case of the MIMO scheme described above, the baseband signal generation unit 110 generates the baseband signals (digital signals) BX1 to BXm for testing for every propagation channel that constitutes the MIMO between the base station simulation device 100 and the mobile communication terminal 300 or for every transmit antenna. The number of the propagation channels is determined in advance based on the number of combinations of the number m of antennas at the base station side where a base station is simulated by the base station simulation device 100 and the number n of antennas of the mobile communication terminal 300. For example, in a case where the number m of antennas at the base station side is 3 and the number n of antennas of the mobile communication terminal 300 is 2, the number of propagation channels is m×n=6. Furthermore, in a case where the baseband signal is generated for every transmit antenna, the base signal is generated for every number m of antennas.

For example, in a case where the number of antennas is m and the number of different baseband signals is m, the baseband signal generation unit 110 sends the baseband signals BX1 to BXm to a fading simulator 200 through the output terminals X1 to Xm, respectively. In the meantime, a transmission format may be output using packet transmission. Furthermore, the term output terminal is used here (this is the case with an input terminal of the fading simulator 200 that will be described below), but in a case where there is a need to match interfaces in order to transmit the baseband signals BX1 to BXm in a specific format, an interface (I/F) may be provided to the output terminal (or the input terminal).

Generally, connections between output terminals (output terminals of the baseband signal generation unit 110) of the base station simulation device 100 and input terminals X1 to Xm of the fading simulator 200 are made with cables.

On the other hand, the arithmetic operation unit 210 receives the m baseband signals BX1 to BXm, and outputs n fading signals FX1 to FXn that have fading effects H which are designated by performing an arithmetic operation on the received m baseband signals BX1 to BXm, respectively. The fading effect H, for example, occurs as a result of the arithmetic operation unit 210 performing an arithmetic operation as illustrated in the following Equation (1).

That is, the arithmetic operation unit 210 generates n baseband fading signals FX1 to FXn as expressed by Equation (1), by applying the weighting factors H11 to Hnm to the baseband signals BX1 to BXm.

$$[ \begin{matrix}FX 1 \\ FX 2 \\ ⋮ \\ ⋮ \\ FXn\end{matrix} ] = [ \begin{matrix}{H}_{11} & {H}_{12} & … & … & {H}_{1 m} \\ {H}_{21} & & … & & {H}_{2 m} \\ ⋮ & & … & & ⋮ \\ ⋮ & & … & & ⋮ \\ {H}_{n 1} & & … & & {H}_{nm}\end{matrix} ] [ \begin{matrix}BX 1 \\ BX 2 \\ ⋮ \\ ⋮ \\ BXn\end{matrix} ] \qquad ( 1 )$$

As known from Equation (1), for example, the fading effect is also changed due to incorrect connections of input positions of the baseband signals BX1 to BXm that are input into input terminals, respectively, of the arithmetic operation unit 210, for example, in a case where the baseband signal BX2 is incorrectly input into an input terminal into which the baseband signal BX1 has to be input and the baseband signal BX1 is incorrectly input into a place (a terminal) to which the baseband signal BX2 has to be input. To be more precise, despite the fact that a fading effect of a parameter H₁₁ has to be normally performed on the baseband signal BX1, a fading effect of a parameter H₁₂ is performed on the baseband signal BX1. Therefore, there is a need to uniquely determine input positions of the baseband signals BX1 to BXm with respect to the arithmetic operation unit 210 in performing designated fading processing. However, there is a concern that an incorrect connection (a human error) will be made in an input connection such as a cable.

An object of the present invention is to provide a fading simulator and a mobile terminal testing system that are capable of performing designated fading processing without depending on a method of an input connection.

### Means for Solving the Problem

In order to accomplish the object described above, according to an invention that is defined in claim 1, there is provided a fading simulator that includes an arithmetic operation unit that has m first input terminals and that performs designated fading processing on m baseband signals that are received in the m first input terminals, respectively, and thus outputs n fading signals, with identifiers being attached to the m first input terminals, respectively, of the arithmetic operation unit, the simulator including: an input control unit that has m second input terminals and that receives m transmission signals each of which includes the identifier and the baseband signal, in the second input terminals, detects each of the identifier which is included in each of the transmission signals, and thus inputs each of the baseband signals together with the identifiers, into each of the first input terminals to which the same identifier as the identifier that is included in each of the transmission signals is attached.

Furthermore, according to an invention that is defined in claim 2, in the fading simulator according to claim 1, the input control unit may include an input information detection unit that has the m second input terminals, and that receives m transmission signals each of which includes the identifier and the baseband signal, in the second input terminals, detects each of the identifier, and thus generates each of combination information which results from combining the detected identifier and information that specifies each of the second input terminals which receives the transmission signal that includes the detected identifier, and an input switching unit that, referring to each of the combination information, may input each of the baseband signals, into each of the first input terminals to which the same identifier as the identifier that is combined with the information which specifies each of the second input terminals is attached.

Furthermore, according to an invention that is defined in claim 3, in the fading simulator according to claim 2, the transmission signal may be a packet signal that includes the identifier and the baseband signal which corresponds to the identifier, and the identifier may be transmitted to the input information detection unit and the corresponding baseband signal may be transmitted to the input switching unit.

Furthermore, according to an invention that is defined in claim 4, in the fading simulator according to claim 1, the arithmetic operation unit may perform the fading processing that assigns and adds n weighting factors to the m baseband signals, respectively.

Furthermore, according to an invention that is defined in claim 5, there is provided a mobile terminal testing system including: a fading simulator that includes a baseband signal generation unit that generates multiple different baseband signals, and an arithmetic operation unit that has m first input terminals and that performs designated fading processing on m baseband signals that are received in the m first input terminals, respectively, and thus outputs n fading signals; and a transmission unit that receives the n fading signals and outputs the received n fading signals to a testing-target mobile communication terminal, in a state of being modulated onto carrier waves respectively, in which the baseband signal generation unit outputs a transmission signal in which a different identifier is attached to every different baseband signal, and in which, with identifiers being attached to the m first input terminals, respectively, of the arithmetic operation unit, the simulator includes an input control unit that has m second input terminals and that receives m transmission signals each of which includes the identifier and the baseband signal, in the second input terminals, detects each of the identifier which is included in each of the transmission signals, and thus inputs each of the baseband signals, into each of the first input terminals to which the same identifier as the identifier that is included in each of the transmission signals is attached.

Furthermore, according to an invention that is defined in claim 6, in the mobile terminal testing system according to claim 5, the input control unit may include an input information detection unit that has the m second input terminals, and that receives m transmission signals each of which includes the identifier and the baseband signal, in the second input terminals, detects each of the identifier, and thus generates each of combination information which results from combining the detected identifier and information that specifies each of the second input terminals which receives the transmission signal that includes the detected identifier, and an input switching unit that, referring to each of the combination information, inputs each of the baseband signals, into each of the first input terminals to which the same identifier as the identifier that is combined with the information which specifies each of the second input terminals is attached.

Furthermore, according to an invention that is defined in claim 7, in the mobile terminal testing system according to claim 6, the transmission signal may be a packet signal that includes the identifier and the baseband signal which corresponds to the identifier, and the identifier may be transmitted to the input information detection unit and the corresponding baseband signal may be transmitted to the input switching unit.

Furthermore, according to an invention that is defined in claim 8, in the mobile terminal testing system according to claim 5, the arithmetic operation unit may perform the fading processing that assigns and adds n weighting factors to the m baseband signals, respectively.

### Advantage of the Invention

A fading simulator according to the present invention is configured to detect an identifier from a transmission signal that includes a baseband signal to which the identifier that is input at the arithmetic operation unit side is attached, and to connect the baseband signal to which the identifier is attached, to an input terminal of the arithmetic operation unit, of which an identifier is the same as the identifier. Thus, a connection to an input position to which the same identifier as the identifier that is attached to the baseband signal is attached can be reliably made. Accordingly, the input position of the baseband signal in fading processing can be uniquely determined. For this reason, fading processing that is designated in advance can be reliably performed on the baseband signal that is transmitted, without depending on a method of an input connection.

### BRIEF DESCRIPTION OF THE DRAWINGS

FIG. 1 is a block diagram illustrating a functional configuration according to an embodiment of the present invention.

FIG. 2 is a diagram for describing operation of an input switching unit and an output switching unit according to the embodiment of the present invention.

FIG. 3 is a diagram for describing a transmission signal that includes an identifier and a baseband signal.

FIG. 4 is a diagram for describing a technology in the related art.

### BEST MODE FOR CARRYING OUT THE INVENTION

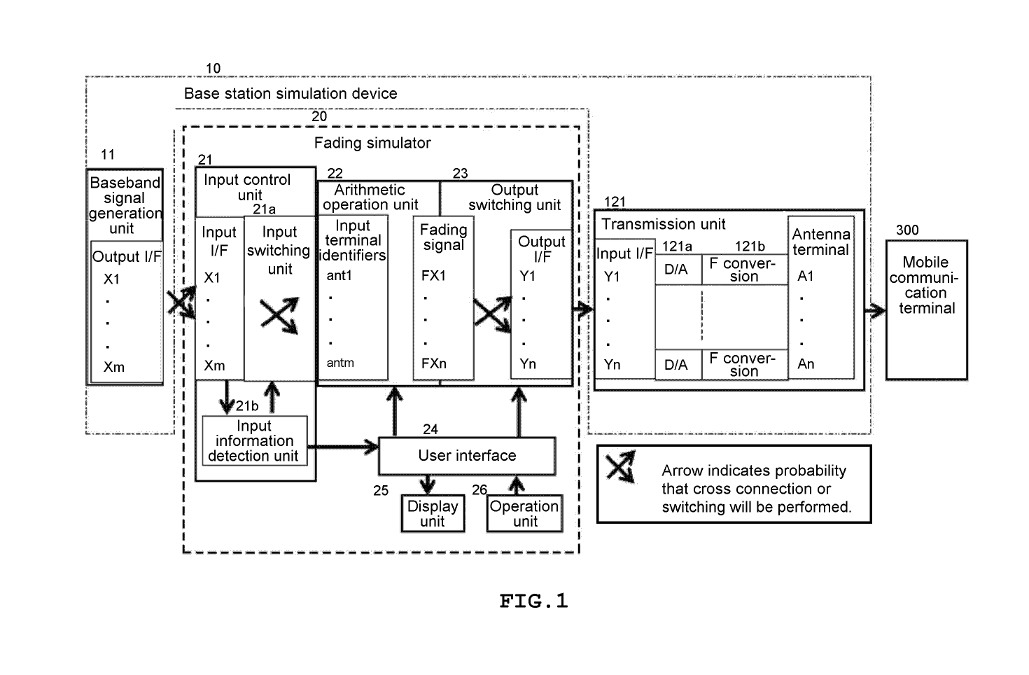

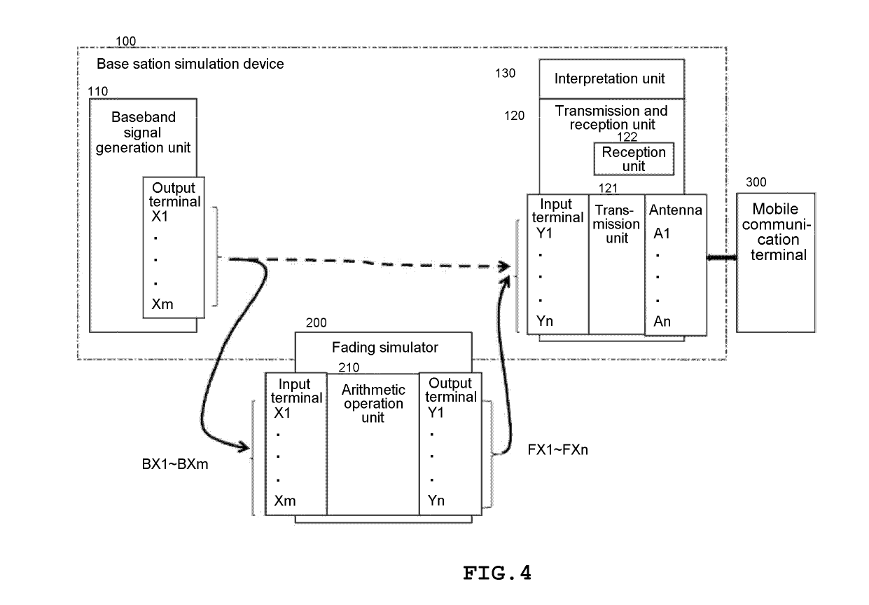

An embodiment of the present invention is described referring to FIG. 1. A mobile terminal testing system that is illustrated in FIG. 1 is configured from a base station simulation device 10 and a fading simulator 20. The base station simulation device 10 in FIG. 1 and a base station simulation device 100 in FIG. 4 that illustrates an example in the related art have a baseband signal generation unit 11 in FIG. 1 and a baseband signal generation unit 110 in FIG. 4, respectively, that are different from each other, but have basically the same mechanism in terms of a configuration except for this difference. Moreover, in the base station simulation device 10 in FIG. 1, a reception unit 122 or an interpretation unit 130 in FIG. 4 are omitted.

Furthermore, in the fading simulator 20 in FIG. 1 and a fading simulator 200 in FIG. 4, an arithmetic operation unit 22, an input I/F, and an output I/F in FIG. 1 have the same functions as an arithmetic operation unit 210, an input terminal thereof, and an output terminal thereof in FIG. 4, respectively. What distinguishes the fading simulator 20 in FIG. 1 and the fading simulator 200 in FIG. 4 is that an input terminal of the arithmetic operation unit 22 in FIG. 1 has identifiers and that the fading simulator 20 in FIG. 1 includes an input switching unit 21a, and input information detection unit 21b, and an output switching unit 23, and the like.

The mobile terminal testing system is configured from the base station simulation device 10 and the fading simulator 20 that is externally attached to the base station simulation device 10. The base station simulation device 10 is configured in such a manner that the base station simulation device 10 can communicate with a mobile communication terminal 300 in a wireless or wired manner.

The base station simulation device 10 is configured to include the baseband signal generation unit 11, a transmission unit 121 and a reception unit (which are not illustrated in FIG. 1), and an interpretation unit (not illustrated). The fading simulator 20 is connected between the baseband signal generation unit 11 and the transmission unit 121 (a connection relationship is the same as that in FIG. 4). When not in a mode in which testing is performed with the fading simulator 20, the fading simulator 20 is connected as shown with a dotted line in FIG. 4. When in a fading simulation mode, the fading simulator 20 is connected as shown with a solid line in FIG. 4.

The baseband signal generation unit 11 generates m different digital baseband signals BX1 to BXm, and sends the generated m different digital baseband signals BX1 to BXm from output interfaces (output I/Fs) X1 to Xm of itself to input interfaces (input I/Fs) X1 to Xm of the fading simulator 20, respectively.

At this point, an example is described in which the baseband signals BX1 to BXm are transmitted and received in the format of packets between the output I/Fs X1 to Xm of the baseband signal generation unit 11 and the input I/Fs X1 to Xm of the fading simulator 20. Therefore, the output I/Fs X1 to Xm and the input I/Fs X1 to Xm serve as interfaces for signals in the format of packets that flow through the output I/Fs and the input I/Fs, and have the same functions as output terminals and input terminals, respectively. Additionally, the output I/Fs X1 to Xm and the input I/Fs X1 to Xm are set to be connected by an operator with a cable.

The baseband signal generation unit 11 generates desired m different digital baseband signals BX1 to BXm that are designated through a user interface 24 by an operation unit 26, and outputs the generated desired m different digital baseband signals BX1 to BXm in the form of packets from the output I/Fs X1 to Xm, respectively. At this time, the different digital baseband signals BX1 to BXm are output, in a state where identifiers anti to antm for identifying input terminals of the arithmetic operation unit 22 (described below), which are desired to receive input data, are attached to the different digital baseband signals BX1 to BXm, respectively (the identifiers anti to antm are expressed as the input terminals of the arithmetic operation unit 22 in FIG. 1). To be more precise, the baseband signal generation unit 11 outputs transmission signals, that is, the baseband signals BX1 to BXm that are desired to be input into predetermined input terminals of the arithmetic operation unit 22, from the output I/Fs X1 to Xm, respectively, in a state where the identifiers anti to antm that correspond to the predetermined input terminals, respectively, are attached to the transmission signals.

Moreover, in this example, descriptions are provided on the assumption that the identifiers anti to antm are attached to the input terminals X1 to Xm of the arithmetic operation unit 22 in this order: codes X1 to Xm, and that the identifiers anti to antm are attached to the baseband signals that are output from the output I/Fs X1 to Xm, in this order: output I/F codes X1 to Xm.

In an input control unit 21 of the fading simulator 20, the input information detection unit 21b detects the identifiers anti to antm from the transmission signals (each of which is the baseband signal BX+ the identifier ant) that are input into the input I/Fs X1 to Xm, and generates and stores pieces of combination information that result from combining the input I/Fs X1 to Xm and the identifiers anti to antm that are detected in the input I/Fs X1 to Xm, respectively. Then, when the combination information, for example, is [input I/F Xh, antk], the input information detection unit 21b causes the input switching unit 21a to connect the input I/F Xh that receives the transmission signal and the input terminal antk of the arithmetic operation unit 22 that has the same identifier antk as the identifier antk that the transmission signal has, and causes the baseband signal BXk, which is input together with the identifier antk, to be input into the input terminal antk of the arithmetic operation unit 22. The input switching unit 21a has a switching function, and, according to an instruction of the input information detection unit 21b, inputs the baseband signals BX1 to BXm to which the same identifiers anti to antm as the identifiers anti to antm of the input terminals of the arithmetic operation unit 22 are attached, respectively, into the input terminals (the identifiers anti to antm) of the arithmetic operation unit 22, respectively. The input terminals of the arithmetic operation unit 22 are hereinafter referred to as input terminals anti to antm, respectively.

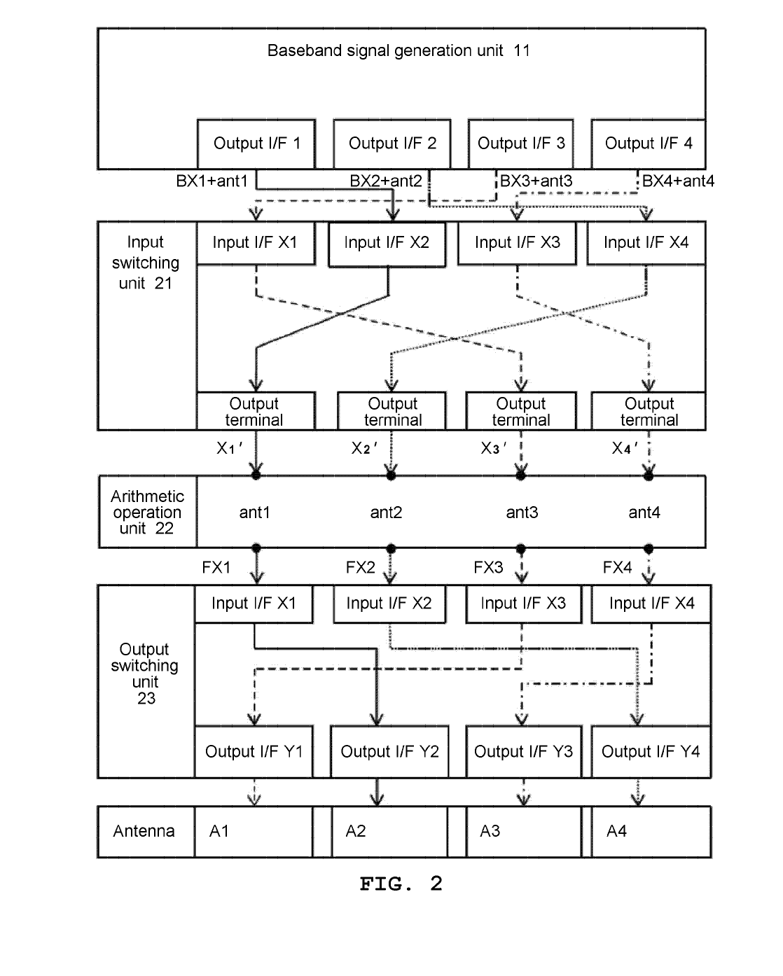

A switching control operation by the input control unit 21 that includes the input information detection unit 21b and the input switching unit 21a in the fading simulator 20 will be described below in terms of signal flow referring to FIG. 2. FIG. 2 is a diagram for describing a switching control operation by the input control unit 21 in a case where the number of input I/Fs is 4 and the number (the number of outputs) of antennas is (4 inputs and 4 outputs).

The input information detection unit 21b generates pieces of combination information that result from combining input I/F numbers X1 to Xm that is possible when identifiers are detected and the detected identifiers anti to antm, respectively, and outputs the pieces of combination information to the input switching unit 21a. In an example in FIG. 2, when it is detected that the baseband signal BX3 to which the identifier ant3 is attached is input into the input I/F X1, the input I/F X1 and the identifier ant3 is generated as combination information. In the same manner, combination information that includes the input I/F X2 and the identifier anti, combination information that includes the input I/F X4 and the identifier ant2, and combination information that includes the input I/F X3 and the identifier ant4 are generated by the input information detection unit 21b, and the generated pieces of combination information are sent to the input switching unit 21a.

The input switching unit 21a receives the combination information that includes the input I/F X1 and the identifier ant3, from the input information detection unit 21b, and inputs the baseband signal BX3 that is input to the input I/F X1 into the input terminal ant3 of the arithmetic operation unit 22 to which the identifier ant3 is attached. In the same manner, the combination information that includes the input I/F X2 and the identifier anti is received, and the baseband signal BX1 that is input into the input I/F X2 is input to the input terminal anti of the arithmetic operation unit 22. The combination information that includes the input I/F X4 and the identifier ant2 is received, and the baseband signal BX2 that is input into the input I/F X4 is input to the input terminal ant2 of the arithmetic operation unit 22. The combination information that includes the input I/F X3 and the identifier ant4 is received, and the baseband signal BX4 that is input into the input I/F X3 is input to the input terminal ant4 of the arithmetic operation unit 22.

A switch mechanism in which the input switching unit 21a performs switching may be a matrix switch and may have a configuration in which the switching function is performed with an arithmetic logic operation.

One example in which the switching is performed with the arithmetic logic operation is described using the following two antennas and two baseband signals. The input switching unit 21a performs the arithmetic logic operation in the following Equation (2).

$$[ \begin{matrix}{X}_{1}^{′} \\ {X}_{2}^{′}\end{matrix} ] = [ \begin{matrix}{A}_{11} & {A}_{12} \\ {A}_{21} & {A}_{22}\end{matrix} ] [ \begin{matrix}BX 1 \\ BX 2\end{matrix} ] \qquad ( 2 )$$

BX1 and BX2: baseband signals (which are equivalent to input into the input switching unit 21a) that are input into the input I/Fs X1 and X2, respectively.

X₁′ X₂′: baseband signals that are input into the input terminals anti and ant2 (equivalent to the output terminal of the input switching unit 21a), respectively, of the arithmetic operation unit 22.

A₁₁ to A₂₂ are assigned values based on the pieces of combination information that are detected and generated in the input information detection unit 21b, as follows.

A₁₁=(result of detecting the input I/F X1=32 the identifier anti?)

Aₗ₂=(result of detecting the input I/F X2==the identifier anti?)

A₂₁=(result of detecting the input I/F X1==the identifier ant2?)

A₂₂=(result of detecting the input I/F X2==the identifier ant2?)

If a proposition in parentheses is true, this proposition is set to“1”. If a proposition in parentheses is false, this proposition is set to“0”.

For example, the following cases are possible.

(a) In a case where the identifier anti and the identifier ant2 are detected in the input I/F X1 and the input I/F X2, respectively, arithmetic operations, that is, A₁₁=A₂₂=0 and Aₗ₂=A₂₁=0, are performed, and the input I/F X1 and the input I/F X2 are connected to the input terminal anti of the arithmetic operation unit 22 and the input terminal ant2 of the arithmetic operation unit 22, respectively.

(b) In a case where the identifier ant2 and the identifier anti are detected in the input I/F X1 and the input I/F X2, respectively, arithmetic operations, that is, A₁₁=A₂₂=0 and A₁₂=A₂₁=1, are performed, and the input I/F X1 and the input I/F X2 are connected to the input terminal ant2 of the arithmetic operation unit 22 and the input terminal anti of the arithmetic operation unit 22, respectively. To be more precise, the connections in (a) described above are exchanged.

Moreover, in the arithmetic operation described above, A₁₁ to A₂₂ are described simply with is and 0s.

However, in practice, X₁, X₂, X₁′ and X₂′are pieces of multi-bit digital data, and A₁₁ to A₂₂ are also in multi-bits.

Next, the arithmetic operation unit 22 performs an arithmetic operation (which is an arithmetic operation that causes a fading effect, and is hereinafter referred to as an “fading arithmetic operation”), which is designated at the operation unit 26 side, on the baseband signals BX1 to BXm that are input into the input terminals anti to antm, respectively, of the arithmetic operation unit 22, and outputs N baseband signals on which fading is performed, as fading signals FX1 to FXn, respectively. Moreover, the arithmetic operation by the arithmetic operation unit 22 is performed after the switching by the input switching unit 21a. This timing adjustment may be performed in the input information detection unit 21b, and a configuration may be employed in which a switching termination instruction is received from the input switching unit 21a.

An arithmetic operation expression for the fading arithmetic operation in m inputs×n outputs is shown in Equation (1) described above. Therefore, at this point, the fading arithmetic operation in the 4 inputs and 4 outputs (m=n=4) that is illustrated in FIG. 2 is described. The fading arithmetic operation is performed based on the following Equation (3). Moreover, the fading signals FX1 to FX4 are D/A-converted into analog signals in the transmission unit 121 described below, and the resulting analog signals are output, as carrier signals (RF signals) that are obtained by being up-converted, to the mobile communication terminal 300.

$$[ \begin{matrix}FX 1 \\ FX 2 \\ FX 3 \\ FX 4\end{matrix} ] = [ \begin{matrix}{H}_{11} & … & {H}_{14} \\ {H}_{21} & … & {H}_{24} \\ {H}_{31} & … & {H}_{34} \\ {H}_{41} & … & {H}_{44} \end{matrix} ] [ \begin{matrix}{X}_{1}^{′} \\ {X}_{2}^{′} \\ {X}_{3}^{′} \\ {X}_{4}^{′}\end{matrix} ] \qquad ( 3 )$$

If Equation (3) described above is expanded, for example, the FX1 is obtained by the following Equation (4).

FX1=(H₁₁×X₁′)+(H₁₂×X₂′)+(H₁₃×X₃′)+(H₁₄×X₄′) (4)

Moreover, X₂′ to X₄′ are signals that are input into the input terminals anti to ant4 of the arithmetic operation unit 22, respectively. H₁₁ to H₄₄ are parameters for assigning a weighting factor to each of the baseband signals and thus indicating the fading effect. Multiple types of H₁₁ to H₄₄ may be prepared in advance in the arithmetic operation unit 22 and may be selectively used. A configuration may be employed in which the H₁₁ to H₄₄ are set by the input from the operation unit 26 and the like. FX1 to FX4 are fading signals that have a designated fading effect H. Furthermore, the FX1 to FX4 are baseband signals X₁′ to X₄′ that are input into the input terminals anti to ant4, but in a case where only the fading signals FX1 and FX2 are desired to be extracted, this is possible if the parameters H₃₁ to H₄₄ are set to 0.

The output switching unit 23 performs output switching control for inputting each of the n fading signals FX1 to FXn, which are input from the arithmetic operation unit 22 into the input terminals (not illustrated), into any one of output I/Fs Y1 to Yn that correspond to antennas A1 to An, respectively. Selection of which one of the fading signals FX1 to FXn is output to which one of the output I/Fs (or antennas) is made based on the combination information that is indicated with the operation unit 26 or is set in advance.

These pieces of combination information are pieces of information that indicate connection relationships between the fading signals FX1 to FXn and the output I/Fs Y1 to Yn (the antennas A1 to An), respectively, to the output switching units 23.

For example, when receiving the information that indicates the connection relationship between the fading signal FX3 and the output I/F Y1, the output switching unit 23 performs routing processing that connects the fading signal FX3 to the output I/F Y1.

As described above, the output switching unit 23 can output the fading signals FX1 to FXn from the output I/Fs Y1 to Yn, respectively, that are arbitrary output terminals, and particularly this is convenient in the following cases.

For example, in a case where testing is performed using the fading simulator 20, when the baseband signal with the identifier anti, as illustrated in FIG. 2, is set to be input into the input I/F X3, the fading signal FX1 is correspondingly output. Incidentally, the output switching unit 23 sends the fading signal FX1 to the output I/F Y3 on the assumption that the fading signal FX1 corresponds to the input I/F X3 and sends the fading signal FX1 to the antenna A3 through the input I/F Y3 of the transmission unit 121.

Next, in a case where normal testing is performed without using the fading simulator 20, a cable (a baseband signal to which the identifier anti is attached) that is connected to the input I/F X3 is sent to the antenna A3 through the input I/F Y3 of the transmission unit 121 without any change. By doing this, with the testing with the fading simulation and the testing without the fading simulation, a correspondence relationship between the baseband signal to which the identifier anti is attached and the antenna A3 can be set to be the same. To be more precise, the same connection relationship can be set regardless of the presence or absence of the fading simulation.

In the example described above, in a sense, the output switching unit 23 performs switching that returns the connection relationship which results from the switching by the input switching unit 21a to its original state, based on the pieces of combination information that result from combining the input I/Fs X1 to Xm and the identifiers anti to antm, which are generated by the input information detection unit 21b. The switch mechanism of the output switching unit 23 can be set to have the same configuration as the input switching unit 21a.

In the case of the above-described example in FIG. 2, when the identifiers anti to ant4 are set to be the same as codes A1 to A4 for identifying antennas, a signal relationship can be known in clearer manner.

The transmission unit 121 receives the fading signals FY1 to FYn that are output from the fading simulator 20, converts the received fading signals FY1 to FYn into carrier frequencies, and outputs the resulting carrier frequencies to the mobile communication terminal 300.

A D/A conversion unit 121a D/A-converts the fading signals FY1 to FYn that are input through the input I/Fs Y1 to Yn, respectively. An F conversion unit 121b converts the fading signals FY1 to FYn that result from the D/A conversion by the D/A conversion unit 121a into carrier frequencies, respectively, and outputs the resulting carrier frequencies to the mobile communication terminal 300.

Displayed on a display unit 25 are the pieces of combination information that result from combining the input I/Fs X1 to Xn and the identifiers anti to antm that are attached to the baseband signals which are input into the input I/Fs X1 to Xn, respectively, which are detected by the input information detection unit 21b.

The descriptions are provided above on the assumption that the mobile terminal testing system includes the base station simulation device 10 and the fading simulator 20, but the fading simulator 20 can perform simulation using an independent baseband signal generation unit that is different from that of the base station simulation device 10, and can be set to be a simulation system that is configured from a combination of a baseband signal generation unit and a transmission unit.

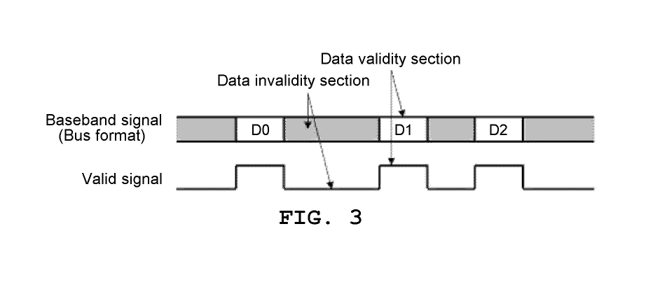

Furthermore, the descriptions are provided to the effect that the transmission signal including the identifiers anti to antm and the baseband signal are sent in the format of packets between the output I/Fs X1 to Xm (the output terminal of the baseband signal generation unit 11) and the input I/Fs X1 to Xm (the input terminal of the fading simulator 20), but the transmission signal may be a signal in the format of a bus as illustrated in FIG. 3. FIG. 3 illustrates the format of sequential transmission on the assumption that a signal indicating an identifier is DO and baseband signals are D1 and D2. A valid signal is a signal indicating whether data is valid or invalid. Therefore, initial data DO is used as data indicating a valid identifier by the input information detection unit 21b, and next and subsequent pieces of data are used as valid data by the arithmetic operation unit 22. Moreover, the valid signal is not necessarily needed. However, as illustrated in FIG. 3, in a case where there is a concern that the baseband signal will be divided into D1 and D2, because it is determined which time span a signal is valid for, reliable transmission can be secured.

### DESCRIPTION OF REFERENCE NUMERALS ND SIGNS

10, 100 BASE STATION SIMULATION DEVICE

11, 110 BASEBAND SIGNAL GENRERATION UNIT

20, 200 FADING SIMULATOR

21 INPUT CONTROL UNIT

22, 210 ARITHMETIC OPERATION UNIT

23 OUTPUT SWITCHING UNIT

121 TRANSMISSION UNIT

300 MOBILE COMMUNICATION TERMINAL

What is claimed is:

1. A fading simulator that includes an arithmetic operation unit that has m first input terminals and that performs designated fading processing on m baseband signals that are received in the m first input terminals, respectively, and thus outputs n fading signals, with identifiers being attached to the m first input terminals, respectively, of the arithmetic operation unit, the simulator comprising:
an input control unit that has m second input terminals and that receives m transmission signals each of which includes the identifier and the baseband signal, in the second input terminals, detects each of the identifier which is included in each of the transmission signals, and thus inputs each of the baseband signals together with the identifiers, into each of the first input terminals to which the same identifier as the identifier that is included in each of the transmission signals is attached.

2. The fading simulator according to claim 1,
wherein the input control unit includes
an input information detection unit that has the m second input terminals, and that receives m transmission signals each of which includes the identifier and the baseband signal, in the second input terminals, detects each of the identifier, and thus generates each of combination information which results from combining the detected identifier and information that specifies each of the second input terminals which receives the transmission signal that includes the detected identifier, and
an input switching unit that, referring to each of the combination information, inputs each of the baseband signals, into each of the first input terminals to which the same identifier as the identifier that is combined with the information which specifies each of the second input terminals is attached.

3. The fading simulator according to claim 2,
wherein the transmission signal is a packet signal that includes the identifier and the baseband signal which corresponds to the identifier, and
wherein the identifier is transmitted to the input information detection unit and the corresponding baseband signal is transmitted to the input switching unit.

4. The fading simulator according to claim 1,
wherein the arithmetic operation unit performs the fading processing that assigns and adds n weighting factors to the m baseband signals, respectively.

5. A mobile terminal testing system comprising:
a fading simulator that includes
a baseband signal generation unit that generates multiple different baseband signals, and
an arithmetic operation unit that has m first input terminals and that performs designated fading processing on m baseband signals that are received in the m first input terminals, respectively, and thus outputs n fading signals; and
a transmission unit that receives the n fading signals and outputs the received n fading signals to a testing-target mobile communication terminal, in a state of being modulated onto carrier waves respectively,
wherein the baseband signal generation unit outputs a transmission signal in which a different identifier is attached to every different baseband signal, and
wherein, with identifiers being attached to the m first input terminals, respectively, of the arithmetic operation unit, the simulator includes
an input control unit that has m second input terminals and that receives m transmission signals each of which includes the identifier and the baseband signal, in the second input terminals, detects each of the identifier which is included in each of the transmission signals, and thus inputs each of the baseband signals, into each of the first input terminals to which the same identifier as the identifier that is included in each of the transmission signals is attached.

6. The mobile terminal testing system according to claim 5,
wherein the input control unit includes
an input information detection unit that has the m second input terminals, and that receives m transmission signals each of which includes the identifier and the baseband signal, in the second input terminals, detects each of the identifier, and thus generates each of combination information which results from combining the detected identifier and information that specifies each of the second input terminals which receives the transmission signal that includes the detected identifier, and
an input switching unit that, referring to each of the combination information, inputs each of the baseband signals, into each of the first input terminals to which the same identifier as the identifier that is combined with the information which specifies each of the second input terminals is attached.

7. The mobile terminal testing system according to claim 6,
wherein the transmission signal is a packet signal that includes the identifier and the baseband signal which corresponds to the identifier, and
wherein the identifier is transmitted to the input information detection unit and the corresponding baseband signal is transmitted to the input switching unit.

8. The mobile terminal testing system according to claim 5,
wherein the arithmetic operation unit performs the fading processing that assigns and adds n weighting factors to the m baseband signals, respectively.
